(19) United States
(12) Patent Application Publication
(10) Pub. No.: US 2016/0334002 A1
(43) Pub. Date: Nov. 17, 2016

(54) NOISE ISOLATION FOR MECHANISMS WITH HIGH SPEED CONES AND CONTROL SYSTEM

(71) Applicant: Richard C. Raney, Round Rock, TX (US)

(72) Inventor: Richard C. Raney, Round Rock, TX (US)

(21) Appl. No.: 15/152,786

(22) Filed: May 12, 2016

Related U.S. Application Data
(60) Provisional application No. 62/160,027, filed on May 12, 2015.

(51) Int. Cl. F16H 57/00; F16H 15/42

(52) U.S. Cl. CPC F16H 57/0006; F16H 15/42

(57) ABSTRACT

The invention is directed to a power transmission system including a noise isolation and control system. In an example, a bearing support member is arranged to support bearings which in turn support high speed conical rotors. The bearing support member itself is not rigidly fastened to the outer case of the mechanism. The bearing support member is not directly attached to the outer case, but is supported in the case by radially oriented attachment members which inhibit or do not transmit radial vibrations to the case. In this way, the vibration, or noise, produced by the high speed conical rotors and their bearings and driving gears, is effectively isolated from and not transmitted to the outer case. The invention also relates to a control system to provide for optimization of the power transmission system operation.

### CROSS REFERENCE TO RELATED APPLICATION

This application claims priority to and the benefit of U.S. Provisional Patent Application No. 62/160,027 filed on May 12, 2015, and is incorporated herein by reference in its entirety.

### FIELD OF THE INVENTION

The present invention pertains to continuously variable ratio drive systems which employ conical rotors.

### BACKGROUND OF THE INVENTION

In the operation of such devices, the conical rotors are generally driven by gears at relatively high rotating speeds. Because of the high rotating speeds, such high speed gears and rotors produce audible whining noises which, typically, are transmitted to the outer case, or housing, of the mechanism so that there is a tendency for a substantial degree of unpleasant audible noise to be present in the vicinity.

It would be desirable to provide such system with noise isolation characteristics to reduce the ambient noise generated by such systems.

Also, in the operation of such devices, the output ratio and speed must be adjusted in response to loads, demands and requirements on the driven load. For instance, one application is oil field pumping units, known as “pump jacks”. It has been determined that by precisely controlling the pumping speed by means of an Infinitely Variable Transmission (IVT) installed between the pumping unit and the driving engine or electric motor, substantial increase in oil production from the well can be achieved, along with other benefits.

In a conventional pump jack operation, a usual Pump Off Control (POC) installed on the well senses whenever the down hole pump is beginning to suck air, or “pump off” and immediately shuts down the pumping unit for a predetermined time period to allow oil production in the well to catch up. Even if the pumping speed is initially set so as to not to “pump off”, the normally changing or dropping of production in the well will cause eventual pump off conditions to occur anyway. After each predetermined time period, the pump jack is restarted and runs until another pump off condition is sensed.

By using an IVT, the pumping speed can be adjusted on-the-go to maintain optimum speed without producing a pump off condition and without needing the pump to be stopped periodically. Up to now, in using an IVT on a pump jack, sucker rod loads and other data must be collected and processed so that the ratio and output speed of the IVT can be periodically reprogrammed and adjusted to maintain optimum pumping speed without pump off. This requires specialized devices and close attention by personnel.

Also, to be put into operation, an IVT installation must be started up or may need to be shut down and restarted at times. The unique characteristics of an IVT require precise start-up and shut-down sequences and procedures, which are difficult to execute manually. An incorrect procedure can cause costly damage to an IVT. It would therefore be desirable to provide a control system to allow effective operation of an IVT.

### SUMMARY OF THE INVENTION

The present invention is therefore directed in part to noise isolation in such systems. In an example, the invention relates to a bearing support member, such as in the form of a symmetrical bulkhead, which is arranged to support the bearings of the high speed rotors, but which itself is not rigidly fastened to the outer case of the mechanism. It has been determined that vibrations from the high speed cones, and their supporting bearings and driving pinions, are generally radial in direction. In prior systems, the bearing support members are rigidly fixed to the outer housing or case. In such an arrangement, the vibrations are transmitted to the outer case so that the outer case amplifies the noise produced by the vibrations. In the present invention, the bearing support member is not directly attached to the outer case, but is supported in the case by radially oriented attachment members which inhibit or do not transmit radial vibrations to the case. In this way, the vibration, or noise, produced by the high speed conical rotors and their bearings and driving gears, is effectively isolated from and not transmitted to the outer case. The outer case can then function as a noise insulator. Thus, the audible noise in the vicinity of the operating mechanism is substantially reduced. Additional noise isolation features may also be employed. The invention therefore provides effective noise isolation in systems using conical rotors driven by gears or the like, at relatively high rotating speeds.

In addition, the invention relates to a control system that enables the continuously variable ratio drive system, such as an IVT, to automatically and continuously match its output speed to the changing load requirements, such as the production rate of a well, and thus prevent pump off while optimizing production from the well, without any programming or re-programming being required and without needing to periodically stop and restart the pump jack. The control system also enables precise automatic start-up and shut-down sequencing which prevents damaging mistakes. The need for personnel attention, training and skill is minimized.

### BRIEF DESCRIPTION OF THE DRAWINGS

FIG. 1 is a partially sectioned side view of an apparatus containing and utilizing an example of the present invention.

FIG. 2 is a cross section view of the principal components of the invention.

FIG. 3 is a pictorial drawing of the complete apparatus.

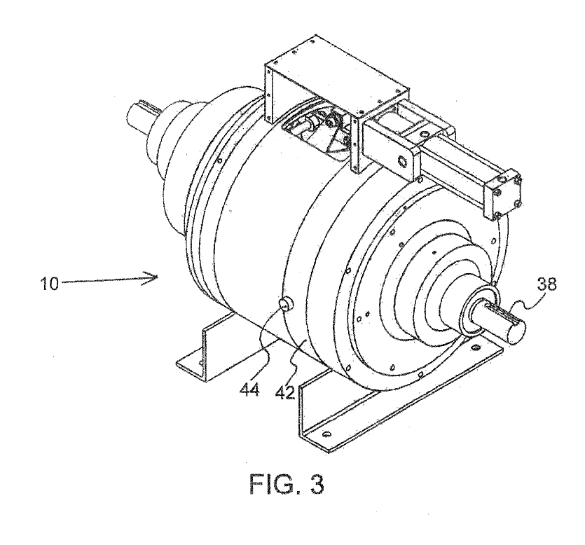

FIG. 4 is an enlarged portion of FIG. 1 showing the principal components along with other components.

FIG. 5 is a partial cross section of the principal components of the invention.

FIG. 6 is a partial view showing aspects of the embodiment of FIG. 1.

FIG. 7 is a schematic of the hydraulics of a control system according to an example.

FIG. 8 is a schematic of the electrical system of a control system according to an example.

FIG. 9 is a schematic of the example of an IVT as shown in FIG. 1.

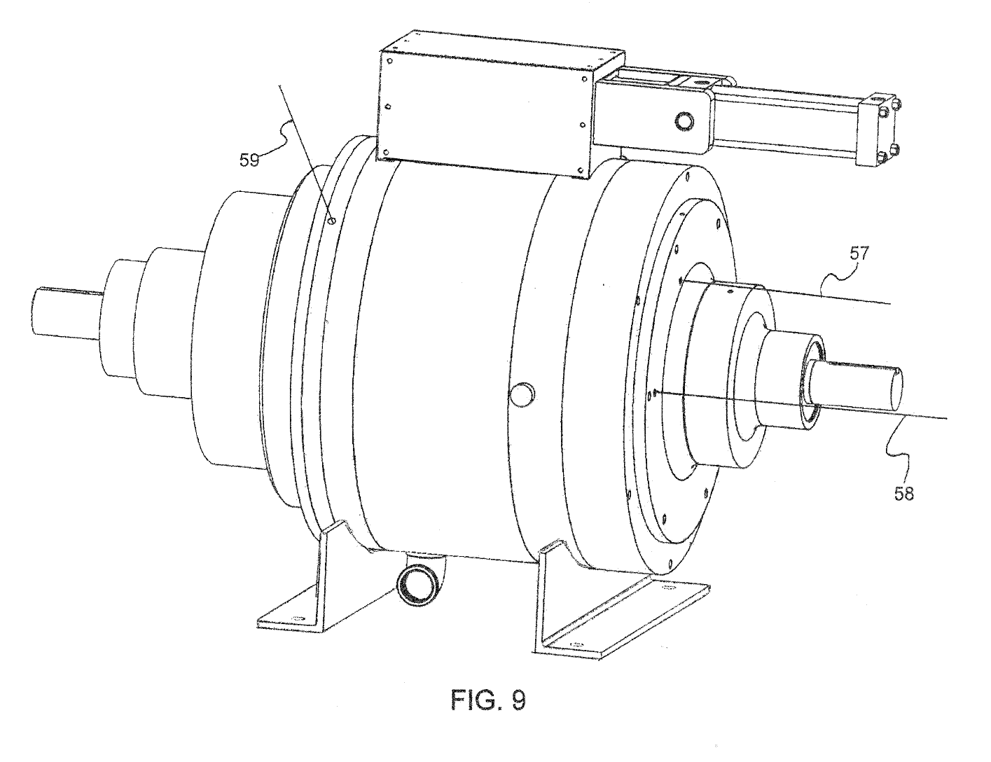

### DETAILED DESCRIPTION OF THE INVENTION

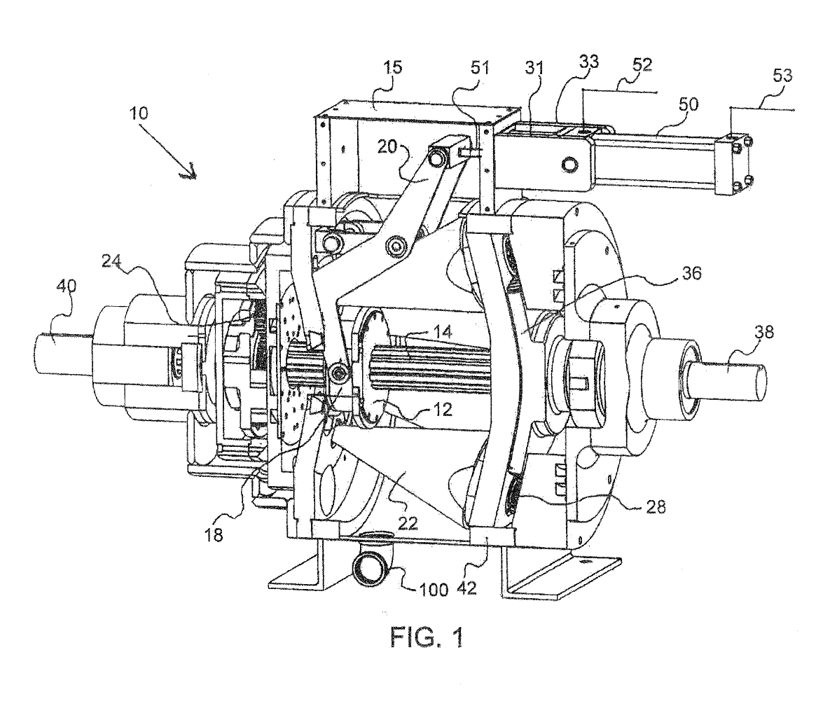

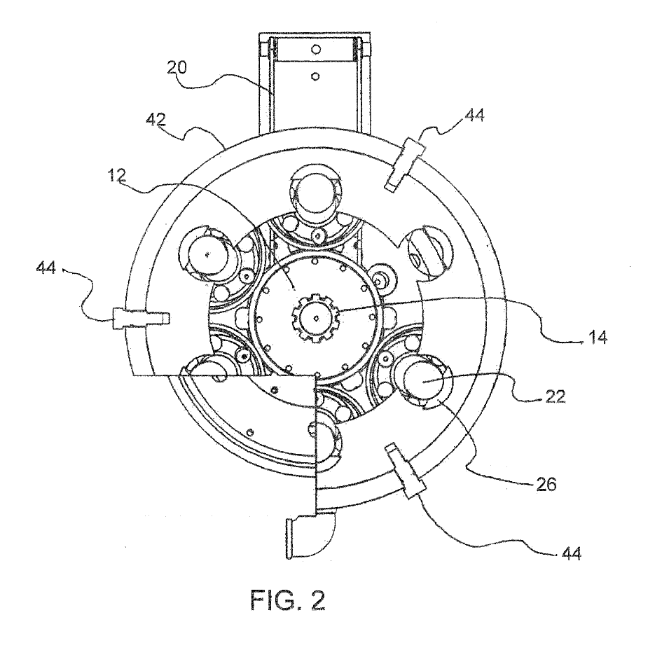

In FIGS. 1 and 2, there is shown an example of a power transmission apparatus according to an example of the invention. The power transmission 10 is shown in a typical environment wherein the apparatus 10 is used to drive a machine geared drives commonly referred to as “gear motors”. Gear motors drive a wide range of different industrial machines, such as pumps, conveyors, rock crushers, rotary kilns, hoists, types of vehicles, and other machines or devices. The transmission may comprise a central, tractionally driven member or disk 12 mounted upon and with a supporting coaxial splined shaft 14, which may be hollow. In this example, all elements of the apparatus are located generally within a housing 16. Disk 12 is arranged to travel axially along shaft 14 in a low friction manner while simultaneously transmitting torque cooperatively. The mating spline structure of disk 12 and shaft 14 are generally known and therefore is not shown in detail here.

A shifting collar 18 is connected to disk 12 by means of an appropriate bearing (not shown), such as a thrust bearing within the collar. The axial position of the disk 12 is adjusted by suitable devices or systems, such as alternative forms of cylinders, levers, actuating arms or other suitable systems. In the example shown in FIG. 1, the a floating lever 20 is pivotally mounted so as to control the axial position of disk 12. The driven end of lever 20 is pivotally attached to an actuator (not shown) which can be either electrically, hydraulically or otherwise suitably actuated.

In this example of a power transfer system, a plurality of conical rotors 22 are symmetrically positioned circumferentially about disk 12 so that the inwardly facing sides of the cones 22 are parallel to shaft 14 and in frictional engagement with the rim of disk 12. In this example, six cones 22 may be provided about the periphery of disk 12.

The torque output from disk 12 is generally proportional to the applied traction contact normal load and number of traction contact points. The optimum number of traction drive members or cones 22 may be therefore chosen for the particular environment and application of the power transfer system. In the present invention, the examples may utilize the optimum number of contact points to provide optimum power output, with final output speed predetermined by a differential gear assembly 24 (see FIG. 1). The disk member 12 as well as the traction drive member(s) or cone 22 are designed and arranged to sustain relatively high rotating speeds without causing premature failure. It is also noted that the cones 22 of this example are fifteen degree (15°) cones each having approximately four to one (4:1) diametrical ratio, although other examples might include cones of a different angle, size and ratio configuration. Any suitable cone assembly arrangements are contemplated for different environments and/or applications.

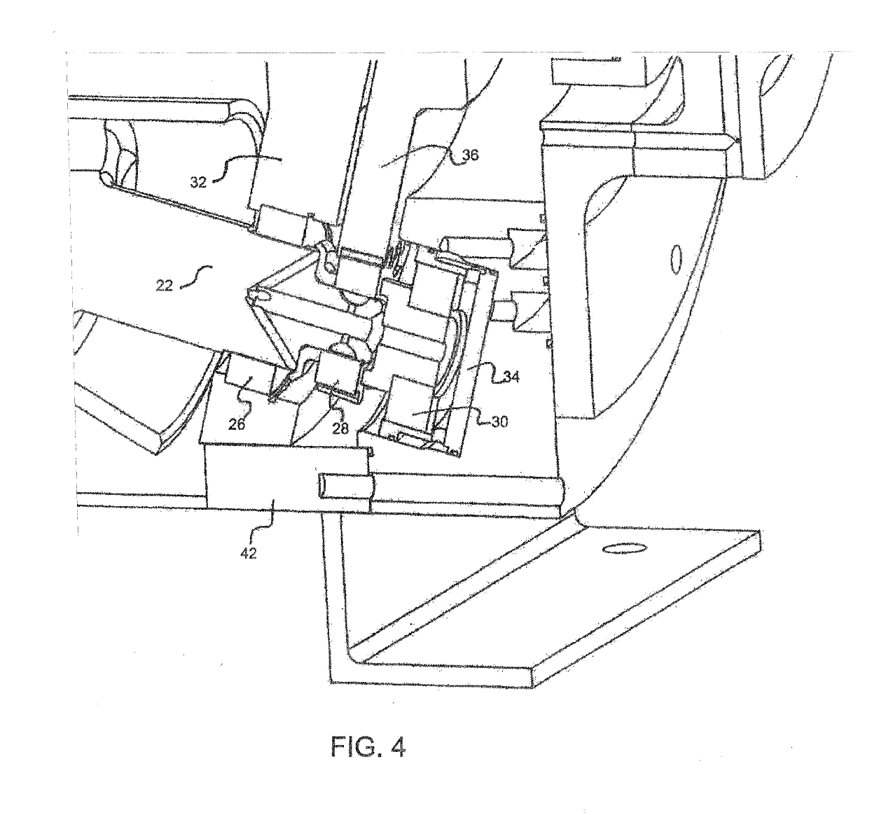

As shown in FIG. 2, each cone 22 includes a concentric shaft extending from the big end of each and supported by bearing 26. A drive pinion 28 is provided at its big end, with a bearing 30 (see FIG. 4), such as a thrust bearing, thrusting against the shaft at its front end, as shown. Bearing 26 may be a cylindrical roller bearing capable of sustaining extremely high rotating speeds and relatively high radial loads. Bearings 26 are supported in bearing races which are mounted in a bearing support 32. Piston 34 applies axial thrust through bearing 12 to cone 22 whenever fluid pressure is directed against piston 34. In this manner, clamping force, or normal force, between cones 22 and disk 12 is achieved to prevent slippage. In this example, the bearings 26, and the mating shaft journals of cones 22, are arranged to allow slight but adequate axial movement of cones 22. Drive pinion 28 may be keyed on its shaft and is retained on its shaft by axial force through bearing 30. Other designs and configurations for cones 22 and these other structures are possible.

As shown in FIG. 1, an input gear 36, such as a ring gear, is provided in common mesh with drive pinions 28 at a step-up ratio of 1:5 or other desired ratio, and is supported in an appropriate bearing. Gear 36 is arranged to be coupled to input shaft 38 and driven by a suitable power source. A planetary gear set 24 including a set of differential output planet gears may be arranged to provide suitable ratios between shaft 14 and output shaft 40.

As shown in FIG. 1, bearings 26 of cones 22 are supported in a bearing support 162. As shown in FIG. 1, the bearing support 32 may be shaped to accommodate the tilt angle of cones 22 and bearings 26, although FIG. 2 shows bearing support 32 as being flat, for clarity of the drawing. Bearings 26 may be commercially available cylindrical roller bearings, or any other suitable bearing configuration for the system. In the invention, a power transmission apparatus employing conical rotors 22, a bearing support 32, such as a bulkhead or suitable frame or structure, has non-rigid contact with the housing 42 of apparatus 10.

In this example, bearing support 32, such as a bulkhead, may be centralized with respect to gear 36 and housing 42 by means of shoulder bolts 44 which are securely and rigidly screwed into mating radial holes machined into the periphery of bearing support 32.

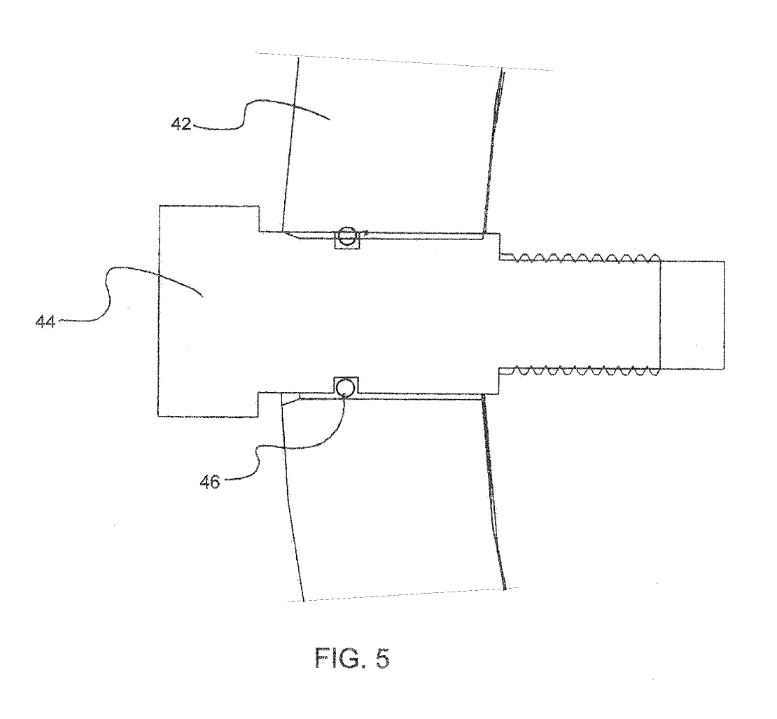

As shown in FIGS. 2 and 5, three shoulder bolts 44 may be mounted radially and symmetrically located 120 degrees apart in matching tapped holes in bearing support 32 and extend radially outward through matching radial holes in housing 42. Other locations of bolts 44 may be used, with it generally being desired to locate the bolts symmetrically about housing 42. The outside diameter of the bearing support 32 is slightly less than the internal diameter of the housing 42, to provide clearance. Also, the bolts 44 may be dimensioned so they can freely move radially relative to their respective mounting holes. The bolts 44 and supporting surfaces may be made of materials that are non-elastic and non-pliable. Oil leakage between the bolts 44 and bearing support 32 may be prevented by o-rings 46 located on each bolt 44. In this way, bearing support 32 and the bearings 26 and cones 22 it supports are held in correct locations, but radial vibrations are not transmitted from bearing support 32 to the housing 42. Instead of radially oriented shoulder bolts, other non-elastic arrangements, such as radially oriented notches, radially oriented keyways or other radially oriented retaining structure could be employed to prevent or minimize the transmission of radial vibrations. In addition, other noise insulating structures may be formed about the rotating cones 22, and associated bearings 26 to minimize or absorb any noise being generated.

Although not shown, the apparatus may include an oil pressure supply system, such as a pump, which supplies oil pressure for lubrication, cooling and ratio control. During operation, pinions 28 and cones 22 generally spin at high speeds which produces high frequency vibrations that are transmitted through bearings 26 into bearing support 32. Being transmitted through bearings 26, the vibrations are generally in a radial direction. Also, since bearing support 32 is not rigidly fastened to housing 42, but only contacts housing 42 through bolts or other retaining structures 44, and since bolts or other retaining structures 44 are radially oriented parallel with the vibrations emitted from gears 28 and cones 22, transmission of vibration to housing 42 will be minimized. In addition, other noise insulating structures may be formed about the rotating cones 22, and associated bearings 26 or around housing 42 to minimize or absorb any vibration/noise being generated. Thus, audible noise in the vicinity of the operating mechanism can be substantially reduced.

In this example, the bearings and their support members located at the small end of cones 22 are not addressed, nor shown in detail, since they are of a different configuration and do not transmit as much vibration and noise as bearings 26. Though these bearing structures pose less of an issue, a similar arrangement may be used to insulate the housing 42 from vibration and transmitted noise. The invention relates to substantially reducing audible noise in the vicinity of a power transmission system 10, providing a system for support for bearings 26, or similar bearing arrangements in such systems, which minimizes transmission of vibration to the outer housing of the system. It should be appreciated that the various features of the presently described systems and methods may be implemented using a variety of hardware configurations. For example, the methods for reducing transmission of vibration using bearing retaining structures that are directed in a corresponding orientation to the generated vibrations from bearing systems, particularly in power transmission systems using high speed rotating elements such as a tractionally driven disk and conical rotors.

In another example, with reference to FIG. 1, an infinitely variable power transmission apparatus (IVT) containing a control system according to an example of the invention is shown in a typical environment wherein the apparatus is used to drive a machine, such as illustrated and described in U.S. Pat. No. 9,328,810. The transmission 10 may comprise a central tractionally driven member or disk 12 mounted upon and with a hollow supporting coaxial splined shaft 14. Note that all elements of the apparatus are located within a housing 16. Disk 12 is arranged to travel axially along shaft 14 in a low friction manner while simultaneously transmitting torque cooperatively. The mating spline structure of disk 12 and shaft 14 may be as shown in U.S. Pat. No. 9,328,810 and therefore is not shown in detail herein.

A shifting collar 18 is connected to disk 12 by means of an appropriate bearing such as a thrust bearing 12 within the collar 18. As shown in U.S. Pat. No. 9,328,810 for example, various alternative forms of cylinders, levers, or arms may be employed to control the axial position of the disk 12. The present embodiment employs a floating lever 20 pivotally mounted so as to control the axial position of the disk 12. The driven end of lever 20 is pivotally attached to an actuator 50 which can be either electrically or hydraulically actuated, but is hydraulically actuated in this embodiment. The actuator, or cylinder 50, has a cylinder rod 51 which is appropriately connected to shifting lever 20, as shown.

A plurality of conical rotors (cones) 22 are symmetrically positioned circumferentially about disk 12 so that the inwardly facing sides of the cones 22 are parallel to the shaft 14 and in frictional engagement with the rim of the disk 12. In the present embodiment, six cones 22 may be provided about the periphery of the disk 12.

The torque output from the disk 12 is proportional to the applied traction contact normal load and number of traction contact points. The optimum number of traction drive members or cones 22 may be therefore chosen for the particular environment and application of the power transfer system. In the present invention, the preferred embodiment utilizes the optimum number of contact points to provide optimum power output, with final output speed predetermined by a differential gear assembly 24.

The disk member 12 as well as the traction drive member or cone 22 are designed and arranged to sustain extremely high rotating speeds without causing premature failure. Note also that the cones 22 of this embodiment are fifteen degree (15°) cones 22 each having approximately four to one (4:1) diametrical ratio, although other embodiments might include cones 22 of a different angle, size and ratio configuration. U.S. Pat. No. 6,001,042 and U.S. Pat. No. 9,328,810 show other suitable cone assembly arrangements as examples, which are hereby incorporated herein by reference.

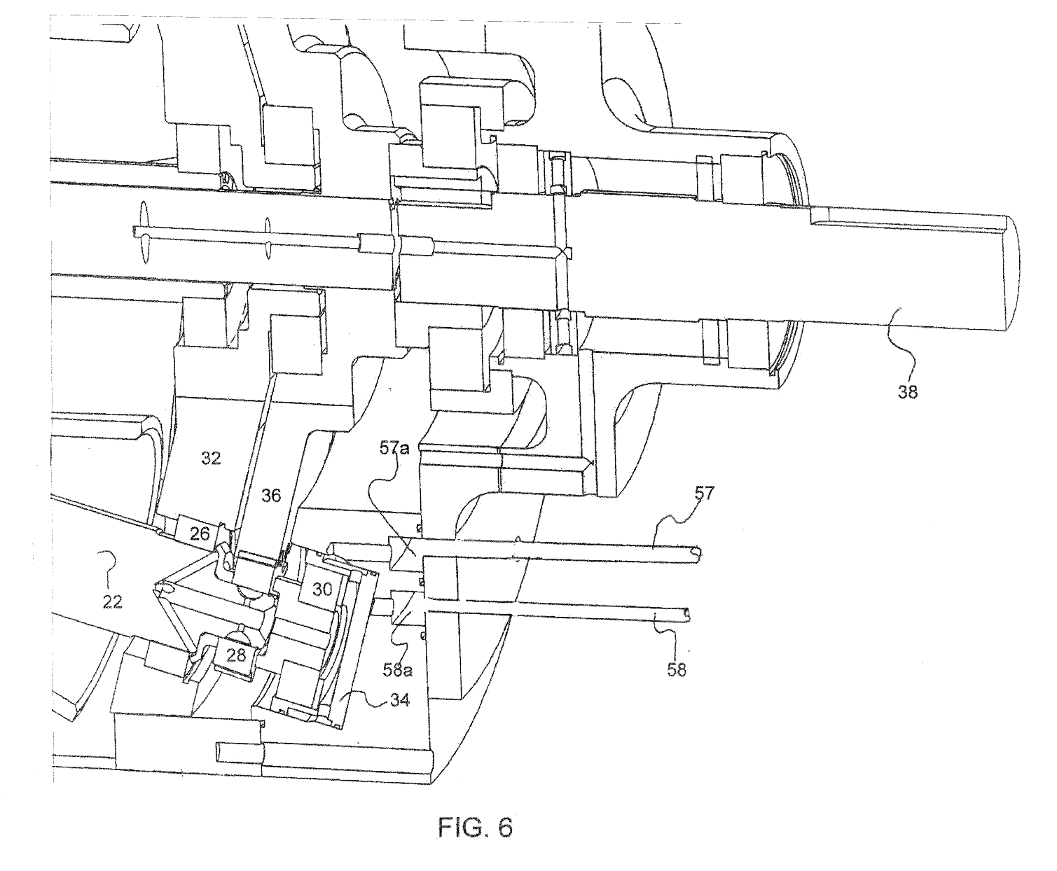

As shown in FIGS. 1 and 6, each cone 22 includes a concentric shaft extending from the big end of each and supported by an appropriate bearing 26. A drive pinion 28 is provided at the cone big end, with a thrust bearing 30 thrusting against the shaft at its front end, as shown. The bearing 26 is, preferably, a cylindrical roller bearing capable of sustaining extremely high rotating speeds and relatively high radial loads. Bearings 26 are supported in bearing races which are mounted in a support bulkhead 32. Piston 34 applies axial thrust through bearing 12 to cone 22 whenever fluid pressure is directed against piston 34. In this manner, clamping force, or normal force, between cones 22 and disk 12 is achieved to prevent slippage. Note that bearings 26, and the mating shaft journals of cones 22, are arranged to allow slight but adequate axial movement of cones 22. Drive pinion 28 may be keyed on its shaft and is retained on its shaft by axial force through bearing 30. Other suitable designs and configurations for cones 22 and these other structures are possible are possible.

As shown in FIG. 1, an input ring gear 36 is provided in common mesh with drive pinions 28 at a step-up ratio of 1:5 and is supported in an appropriate bearing. The input gear 36 is arranged to be coupled to the input shaft 38 and driven by a suitable power source. A set of differential output planet gears 24 is arranged to provide suitable ratios between shaft 14 and output shaft 40.

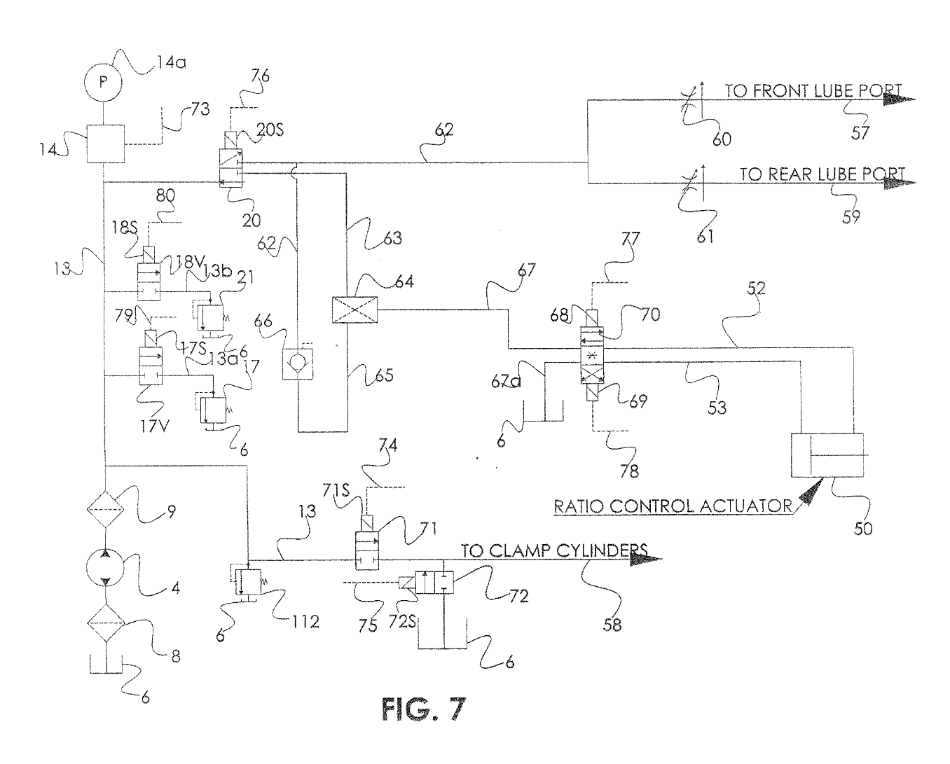

As shown in FIG. 7, bearings 26 of cones 22 are supported in a bearing support bulkhead 32. The support bulkhead 32 is shaped to accommodate the tilt angle of cones 22 and bearings 26. Note that bearings 26 may be commercially available cylindrical roller bearings, but other suitable arrangements may be used.

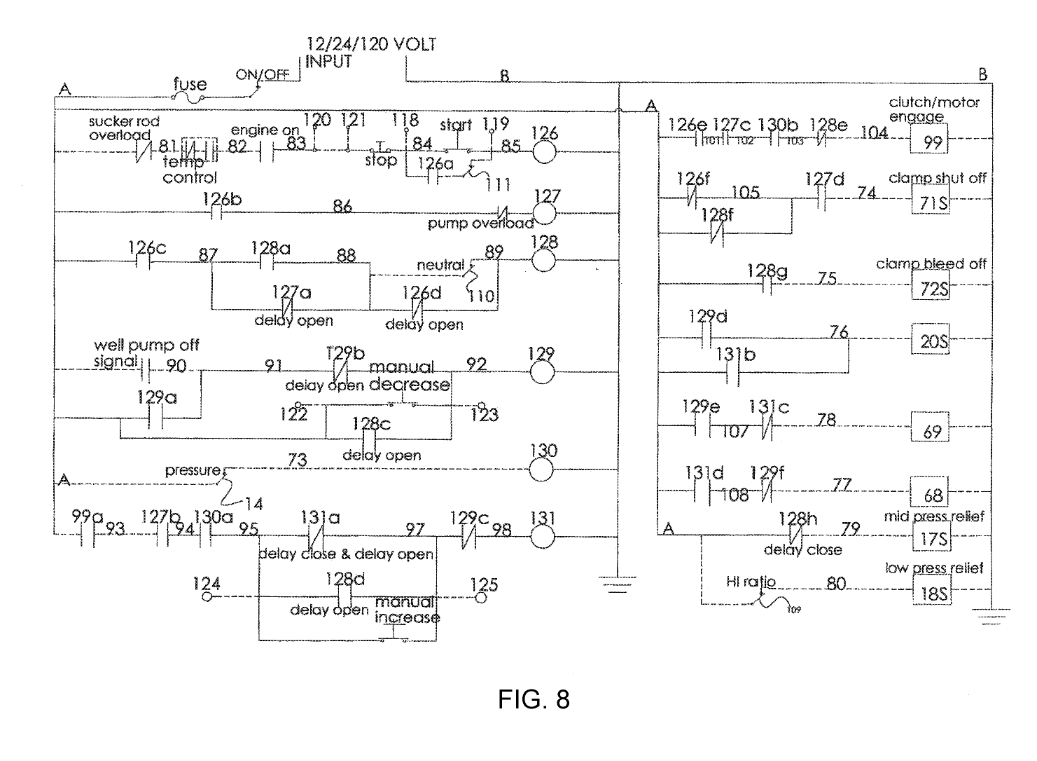

The apparatus will normally include an oil pressure supply system including a pump, tank and valves, which supplies oil pressure for lubrication, cooling and ratio control. Such an oil pressure supply of the type utilizing the present invention can be made commercially available by known means so it is not shown here. The oil pressure and control system of the present invention is shown schematically in FIGS. 7 and 8.

In this example, it is assumed that the subject IVT is installed on a typical oil field pump jack with the IVT to be driven by the usual power source and the pump jack to be driven by the IVT. The drive couplings can be belts and pulleys or direct shaft couplings. The usual power source can be either an engine or an electric motor.

In the case of an electric motor driven pump jack, the power for the circuits shown in FIG. 8 will be taken from the main power grid and the oil pump 4 shown in FIG. 7 will be driven by an electric motor powered by the main grid or other suitable source. In the case of an engine driven pump jack, the circuits shown in FIG. 8 will be powered from an auxiliary generator driven by the engine. The pump 4 can then be directly coupled to the engine, or can be driven by an electric motor powered by the auxiliary generator of the engine. For safe and effective startup of such an IVT, several conditions should be available, including that the oil temperature should be within an acceptable range for effective viscosity and lubrication. This is normally accomplished by a commercially available temperature control module placed in the oil tank. Also, the driving power must be on. In the case of electric drive, the main power must be on. In the case of engine drive, the engine must be running at correct speed with the clutch disengaged. The oil pressure must be up to operating level, and the transmission ratio must be at neutral for startup of rotation. Only when all these conditions are met is it safe to begin rotation of the IVT input shaft.

The following is an explanation of the startup sequence accomplished by the present invention. The person in charge must confirm that main electric power is on, in the case of an electric power pump jack, or that the engine is running at correct speed in the case of an engine driven pump jack. The temperature of the oil in the oil reservoir, or tank 6, must be within a predetermined range so that the oil viscosity will enable the needed lubrication and traction effect. A commercially available temperature control module will normally be placed in the oil tank 6 and can provide closed contacts denoted as “TEMP CONTROL” for the control circuits, as shown in FIG. 8. Many pumped wells are equipped with remote interface systems, so this can be accomplished remotely as well as in person.

With proper conditions confirmed, a start or re-start is accomplished by manually pressing START, shown in FIG. 8, or by remotely initiating start through connections 118 and 119 also shown in FIG. 8. This activates relay 126 which closes contact 126a and keeps relay 126 activated. In the case of an engine driven pump, the pump and oil pressure may already be on, but in the case of an electrically driven pump contact 126b closes to activate the pump relay 127 to start the pump driving motor. When oil pressure is on, pressure switch 11 closes to activate the pressure relay 130. Contact 126c closes to activate the startup relay 128. Note that contacts 127a and 126d are normally closed, delay open contacts so they remain closed long enough to allow contact 128a to close and keep relay 128 activated. During this time, contacts 126e, 128c and 130b are closed, but contact 128e is open so long as relay 128 is energized.

Note that a neutral position switch 110 is connected between wires 88 and 89. Although not physically shown, the neutral position switch 110 is normally mounted on cover plate 15 or otherwise mounted and positioned so that shift arm 20 contacts and opens neutral position switch 110 whenever shift arm 20 moves to the neutral ratio position. In this embodiment, the neutral position of disk 12 is near the big end of cones 22 and cylinder rod 51 is almost fully extended. Switch 110 may be an oil resistant micro switch or similar switch. In this way, startup relay 128 is activated when arm 20 is away from neutral and is deactivated when arm 20 reaches the neutral position. When arm 20 is at the neutral position to begin with, and switch 110 is open, relay 128 activates only momentarily.

In a case when arm 20 is away from neutral and switch 110 is closed, contact 128c will close and activate ratio reducing relay 129 and keep relay 129 activated until relay 128 de-energizes. During this time, contacts 126f and 128f are open which de-activates solenoid 71S on valve 71. Since valve 72 is normally closed, this shuts off pressure to line 58 and to pistons 34. At the same time, contact 128g is closed which activates solenoid 72S on valve 72. Since valve 72 is normally closed, this opens valve 72 and bleeds all pressure from line 58 and pistons 34. In this way, cones 22 are not pushed, or clamped, against the rim of disk 12 so that disk 12 can easily shift along shaft 14 without any effect on disk 12 or cones 22. Note that input shaft 54 is not rotating at this time.

During this time pump 4 supplies oil pressure into main line 13. Contact 128h is now open which de-energizes solenoid 17S and closes valve 17V. Hi-ratio switch 109 is mounted and positioned to close only when arm 20 is near its highest ratio position so that solenoid 18S is now de-energized which closes valve 18V. Thus, oil pressure in line 13 is controlled by relief valve 112 which is preset for 60-65 psi in this embodiment. Contact 129d is now closed which activates solenoid 20S which in turn shifts cylinder activation valve 19 so that oil pressure from line 13 now enters line 63 to pressure intensifier 64. Note that intensifier 64 may be a shuttle piston type having 1:10 pressure increasing capability. The low pressure exhaust from intensifier 64 is directed through line 65 and check valve 66 to line 62 and to lubrication flow control valves 60 and 61. Note that valves 60 and 61 are pressure compensated flow control valves which maintain a set flow rate even if the pressure exceeds the set minimum. Thus, oil continuously flows through lines 57 and 59 to cool and lubricate the various bearings and elements of the assembly. The high pressure output from intensifier 64 is directed through line 67 to directional valve 70. Contact 129e is now closed which activates solenoid 69 which shifts valve 70 to direct oil pressure through line 53 to actuator 50 so that actuator 50 shifts disk 12 towards lower ratio. The exhaust from actuator 50 now passes through line 51 and valve 70 back to tank 6.

When disk 12 and arm 20 reach the neutral ratio position, switch 110 opens which de-energizes relay 128. Note that contacts 127a and 126d are already open. Contact 128c is a timed open contact so that relay 129 remains energized for enough time to allow appropriate valve actions to take place and shaft 54 to come up to speed before being de-energized—generally approximately 20 seconds. Contact 128e closes to activate the clutch or main electric motor, as the case may be, so that shaft 54 begins to rotate. Contact 128f closes to activate solenoid 71S and open valve 71. Contact 128g opens to de-energize solenoid 72S and close valve 72 so that full pressure is directed through line 58 to all pistons 34 which clamp cones 22 against the rim of disk 12. Contact 128h is a timed delay close contact—generally 10 seconds—so that valve 17V remains closed until contact 128h closes and activates solenoid 17S. In this way, the clamping force between cones 22 and disk 12 is at full strength during start up of rotation to handle any possible starting torque surges. When contact 128h closes and activates solenoid 17S, valve 17V opens to direct pressure from line 13 to relief valve 17 which is set at medium pressure—generally 40 psi. Now the cones 22 and disk 12 are fully rotating and clamped together at medium force for steady operation.

When contact 128c does open after its time, relay 129 will be de-energized since contact 129b is already open. This closes contact 129c. Contacts 99a, 127b, 130a and 128d are already closed, so relay 131 is now activated. Contact 131a is both a timed open and timed closed contact, but its opening time is generally only 2-3 seconds so it now opens before contact 128d. Contact 128d is a timed open contact having more opening time set than contact 128c. The opening time of contact 128d is set so that relay 131 remains energized long enough to bring the ratio of disk 12 up to an effective ratio—generally 5-10 seconds longer than the time set on contact 128c. To bring up the ratio of disk 12, contact 131b closes to activate solenoid 19S and shift valve 19 to direct pressure through line 616 as previously described. Contact 131d closes to activate solenoid 68 which shifts valve 70 to direct pressure through line 52 to actuator 50 to shift arm 20 and disk 12 towards higher ratio. Thus, output shaft 40, and the driven pump jack, is smoothly brought up to a preset speed. Note that contact 128h has sufficient opening delay time so that full clamping force between the cones 22 and disk 12 is maintained until output shaft 40 has begun to rotate. After contact 128h times open, the clamping force between the cones 22 and disk 12 drops to normal operating clamping force for maximum durability. The output speed of output shaft 40 may alternately be increased by pressing the “MANUAL INCREASE” button shown in FIG. 8, or by remote means through terminals 124 and 125, which activates relay 131 and the various valves as previously described. When a suitable output speed is achieved and relay 131 is de-energized, valves 19 and 70 are also deactivated. When deactivated, valve 19 directs pressure into line 62 instead of into line 63 so that lubrication oil flow through lines 57 and 59 is maintained, valve 70 shuts off flow to and from actuator 50 and intensifier 64 is dormant. Thus, disk 12 is held in a steady ratio position and the IVT and the driven pump jack are now in normal operating condition.

During normal steady operation, contacts 99a, 127b and 129c will be closed so that whenever contact 131a closes, relay 131 is energized to activate valves 19 and 70 which causes disk 12 to be shifted towards a higher ratio, as previously described. Contact 131a is timed open and also timed close, but is closed when relay 131 is energized through contact 129c. The opening delay time of contact 131a is generally 2-5 seconds which allows disk 12 to move towards a higher ratio for only a short time and for only a short distance which increases the speed of shaft 47 slightly. The closing time delay of contact 131a is generally 4-5 minutes. When the closing time of contact 131a expires and contact 131a closes, relay 131 is again energized which activates the brief ratio increase sequence previously described. Thus, during normal operation the speed of shaft 47, and the pumping speed of the driven pump jack, is periodically increased slightly. Hence, the pumping speed is gradually increased until a “pump-off” signal is received from the Pump Off Control (POC) on the well being pumped.

The pump-off signal from the POC is usually provided by a momentary contact as denoted by “WELL PUMP-OFF SIGNAL” shown in FIG. 8. This energizes ratio reducing relay 129 through contact 129b which is closed at this time. Ratio reducing relay 129 activates valves 19 and 70 to shift disk 12 towards a lower ratio, as previously described. Contact 129b is a timed to open contact to keep ratio reducing relay 129 energized for an appropriate amount of time. Depending on the shifting rate of actuator 50 and disk 12, the time of contact 129b is generally set to expire when the ratio of disk 12 and the speed of shaft 47 are reduced by approximately 15-20%. In this way, the oil production in the well is allowed to catch up with the pumping rate without actually stopping the pump jack. Now, contact 129c closes so the periodic gradual ratio increases resume and normal operation continues until another pump-off signal is received. In this way, the pumping rate will always automatically generally match the production rate of the well, even if the production rate changes, while the pump jack never needs to stop.

Pumping speed can alternately be reduced by manually pressing the “MANUAL DECREASE” button shown in FIG. 8, or by remote means through terminals 122 and 123.

If, during normal operation, the ratio position of disk 12 and shift arm 20 moves close to the highest ratio, normally open switch 109 will be contacted by shift arm 20 and closed which energizes solenoid 21S and opens valve 21V to allow pressure in line 13 to exit through relief valve 21. Relief valve 21 is generally set for 25-30 psi so that when the disk ratio is near the highest ratio, the clamping force between cones 22 and disk 12 is reduced below the usual operating force. Thus, provides for optimum durability of the apparatus at high output speeds during which less torque capacity is needed.

The operation can be shut down by manually pressing the “STOP” button shown in FIG. 8, or alternately by a remote circuit through terminals 120 and 121. This de-energizes pilot control relay 126 which in turn de-energizes the pump starting relay 127 and the drive motor/clutch control 99. This also deactivates all the valves so that clamping pressure to pistons 34 is maintained, even after the oil pump stops, and the ratio of disk 12 is unchanged while the mechanism coasts to a stop. In the case of an unplanned shut down due to an engine or motor failure, an oil pump failure, loss of oil pressure, excess oil temperature or total loss of electric power for control, the same sequence occurs to facilitate a safe coast-down of the mechanism. Also, since most wells are equipped with devices to sense and register the pull load on the sucker rod, a contact denoted “SUCKER ROD OVERLOAD” as shown in FIG. 8 can be provided to de-energize relay 126 anytime the sucker rod becomes overloaded, which can happen if the down-hole pump becomes stuck, even during startup.

The control system described above may be built by assembling and hard wiring a set of discrete timing relays, or may be formed by developing and fabricating a solid state module containing the necessary functioning elements. The time settings for the various timed contacts will normally be predetermined and set during assembly, but may be tuned or adjusted by potentiometers included.

Oil wells are typically equipped with remote interface devices which can be adapted for use with this control system. The invention provides for safe and smooth start up or shut down of such a pumping operation, without causing damage to the mechanism. Also, in normal operation, pumping speed is automatically kept optimally matched to the production rate of the well, even as the production from the well changes, without the need for reprogramming or specialized adjustment of the IVT or its ratio, or for any manual intervention.

The examples are described with reference to a general power transmission system and different embodiments for different applications and/or environments are contemplated. Obviously, modifications and alterations within the scope of the invention will occur to others upon reading and understanding the preceding description. It is intended that the invention be construed as including all such modifications and alterations insofar as they come within the scope of the appended claims or the equivalents thereof.

What is claimed is:

1. A power transmission apparatus comprising a housing, and conical rotors, with a big end and a small end, the conical rotors having a concentric shaft extending from the big end and supported by bearings, and
a bearing support for the bearings, the bearing support having non-rigid engagement with the housing.

2. The power transmission apparatus of claim 1 wherein said bearing support is a bulkhead held in position by radially oriented support surfaces.

3. The power transmission apparatus of claim 1 wherein said bearing support is engaged in the housing to prevent rotation of said bearing support relative to said housing.

4. The power transmission apparatus of claim 1 wherein said bearing support is engaged with the housing by radially oriented shoulder bolts.

5. The power transmission apparatus of claim 1 wherein said bearing support is mounted in the housing via radially and symmetrically located tapped holes in the bearing support and retaining structures that extend radially outward through matching radial holes formed in the housing.

6. The power transmission apparatus of claim 18, wherein the retaining structures are radially oriented parallel with the vibrations emitted from the conical rotors.

7. The power transmission apparatus of claim 1, further comprising noise insulating structures formed about the conical rotors, and associated bearings in the housing.

8. The power transmission apparatus of claim 1, wherein upon rotation of the conical rotors in the bearings, the vibrations produced from the rotation are generally in a radial direction.

9. The power transmission apparatus of claim 1 wherein said bearing support is engaged with the housing by radially oriented notches.

10. The power transmission apparatus of claim 1 wherein said bearing support is engaged with the housing by radially oriented keyways.

11. The power transmission apparatus of claim 1 further comprising a central, tractionally driven member mounted on a splined shaft, with the disk arranged to travel axially along shaft while simultaneously transmitting torque cooperatively.

12. A power transmission apparatus comprising a housing, and conical rotors, the conical rotors having a big end and a small end and a concentric shaft extending from the big end supported by bearings, and
a bearing support for the bearings, the bearing support having non-rigid engagement with the housing, and engaged in the housing to prevent rotation of said bearing support relative to said housing by radially oriented fastening systems.

13. A method of reducing noise associated with a power transmission apparatus comprising,
providing a power transmission apparatus having a housing, and driven conical rotors, the conical rotors having a big end and a small end, and a concentric shaft extending from the big end, supporting the concentric shafts extending from the big end with bearings, and supporting the bearings on a bearing support, wherein the bearing support has a non-rigid engagement with the housing.

14. A transmission comprising a drive shaft, a friction disk nonrotatably mounted to said drive shaft, a shifter connected to said friction disk, said shifter moving said friction disk along said drive shaft, at least two cones engaging the periphery of said friction disk, an output shaft and a control system for providing predetermined operational sequences of the transmission by varying the position between the friction disk and cones to vary the output ratio of the transmission.

15. The transmission of claim 14 wherein the predetermined operational sequences are selected from the group consisting of startup and/or shut-down; periodically providing predetermined brief ratio increases by causing movement of the friction disk during normal operation, providing predetermined ratio reduction by causing movement of the friction disk upon receipt of a predetermined signal or combinations thereof.

16. The transmission of claim 14 wherein the control system comprises discrete timing relays.

17. The transmission of claim 14 wherein the control system comprises a solid state module.

18. The transmission of claim 14 wherein the control system is controlled by a remote interface device.

19. The transmission of claim 14 wherein the control system allows initiating rotation start up only when the ratio is at neutral.

20. The transmission of claim 14 wherein the control system provides higher pressure between the during rotation start up and moderated pressure during normal rotation, and reduced pressure during maximum or near maximum output speed of the controlled transmission.
